(19) United States
(12) Patent Application Publication
(10) Pub. No.: US 2016/0198753 A1
(43) Pub. Date: Jul. 14, 2016

(54) LIQUID CONCENTRATED HUMAN MILK FORTIFIER CONTAINING HYPOALLERGENIC PROTEIN AND LUTEIN

(71) Applicant: ABBOTT LABORATORIES, Abbott Park, IL (US)

(72) Inventors: MUSTAFA VURMA, Dublin, OH (US); BRIDGET BARRETT-REIS, Dublin, OH (US); TERRENCE MAZER, New Albany, OH (US); CORYN COMMARE, Lake Geneva, WI (US); MAGGIE HRONCICH, Reynoldsburg, OH (US); JEFFREY BOFF, Dublin, OH (US)

(73) Assignee: ABBOTT LABORATORIES, Abbott Park, IL (US)

(21) Appl. No.: 14/653,102

(22) PCT Filed: Dec. 18, 2013
(86) PCT No.: PCT/US13/75952

§ 371 Date: Jun. 17, 2015

Related U.S. Application Data
(60) Provisional application No. 61/738,463, filed on Dec. 18, 2012.

(51) Int. Cl. A23L 1/0522; A23L 1/303

(52) U.S. Cl. CPC A23L 1/3053; A23L 1/296; A23L 1/3002; A23L 1/3006; A23L 1/304; A23L 1/302; A23V 2002/00

(57) ABSTRACT

The present invention is directed to concentrated liquid human milk fortifiers using extensively hydrolyzed casein as a protein source, a stabilizer system comprising octenyl succinic anhydride modified corn starch in combination with a low acyl gellan gum, and the carotenoid lutein.

### CROSS-REFERENCE TO RELATED APPLICATIONS

This application claims priority to and any benefit of U.S. Provisional Application No. 61/738,463, filed Dec. 18, 2012, the content of which is incorporated herein by reference in its entirety.

### FIELD OF THE DISCLOSURE

The present disclosure relates to a stable, concentrated liquid human milk fortifier containing a hypoallergenic protein source and carotenoids. More particularly, the present disclosure relates to a long term stable, concentrated liquid human milk fortifier containing extensively hydrolyzed casein as a protein source, a stabilizer system, and lutein.

### BACKGROUND OF THE DISCLOSURE

Human milk is generally recognized as an ideal feeding for most infants due to its overall nutritional composition. It is well known and generally accepted that human milk provides infants with unique immunologic and developmental benefits as compared generally to commercially available infant formulas.

For some infants, however, especially preterm infants, human milk does not always meet the complete nutritional needs. Initially, these preterm infants may grow more rapidly than many of their term counterparts, and accelerated growth often requires additional nutrition, which is made possible by the use of a human milk fortifier in combination with human milk. Although these infants still generally benefit from human milk, it is often desirable to supplement their human milk feedings with additional nutrients.

Lutein has been identified in human milk. Lutein is an antioxidant that also happens to concentrate within the retina of the eye. It is generally known that dietary lutein may provide individuals with eye health benefits, and it is speculated that such benefits may be extended to infants receiving lutein from either human milk or supplemented infant formula. It has now been found, however, that lutein concentrations in infant formula must be much higher than the lutein concentrations found in human milk in order to achieve the same plasma lutein concentrations found in breast fed infants due to a lower relative bioavailability of lutein from infant formula. Although infant formulas today typically contain less than about 20 mcg/liter of lutein, most of which comes inherently from added fats and oils, it has now been found that such lutein concentrations must exceed about 50 mcg/liter, preferably from about 100 mcg/liter to about 200 mcg/liter, in order to duplicate plasma lutein concentrations found in exclusively breast fed infants.

Arachidonic acid and docosahexaenoic acid, for example, have been identified in human milk and subsequently added to infant formulas. These fatty acids support brain and vision development in infants, and are now commonly found in commercially available formulas such as Similac® Advance® Infant Formula, Isomil® Advance® Infant formula, and Similac® Special Care® Advance® infant formula, all of which are available from Ross Products Division, Abbott Laboratories, Columbus, Ohio, USA.

It is now believed that a combination of lutein and docosahexaenoic acid may be particularly important in promoting retinal health and vision development in infants. Both materials are present in human milk and both are known to concentrate in the retina in otherwise healthy subjects. Docosahexaenoic acid (DHA), as a polyunsaturated fatty acid, is highly susceptible to damage by oxidation and degradation within the eye, while lutein is a known antioxidant. It is believed that by adding lutein to infant formulas, not only will it concentrate within the retina, it may also reduce oxidative degradation of the retinal DHA and thus further promote retinal health and vision development in the infant.

Consequently, it has also been found that infant formulas containing combinations of lutein and DHA, as described above, should now be formulated with higher ratios (lutein to DHA) than are commonly found in human milk. These weight ratios of lutein (mcg) to DHA (mg) should now range from about 1:2 to about 10:1.

It has also been found that the severity or risk of retinopathy of prematurity (ROP) is influenced by skin carotenoid levels found in preterm infants fed human milk. This finding suggests that preterm infants can be monitored for skin carotenoid concentrations, and then for those infants demonstrating low skin carotenoid levels, supplemental carotenoids may be administered in amounts sufficient to increase skin carotenoid levels, to thus reduce the risk or severity of retinopathy of prematurity.

Most of the human milk fortifiers described in the literature and commercially available have been formulated as reconstitutable powders rather than liquids in order to minimize the volume displacement of human milk by the fortifier. Recently, however, liquid human milk fortifiers, and specifically highly concentrated human milk fortifier liquids, have received more attention as an alternative to powders. Although these highly concentrated human milk fortifiers do generally displace slightly more volume that the conventional powders, the liquids have the significant benefit of being commercially sterile as they can be subjected to sufficient heat treatment during manufacturing, including aseptic manufacturing.

It may also be advantageous to utilize extensively hydrolyzed proteins in human milk fortifiers. Such proteins are generally hypoallergenic and are desirable for use with infants and preterm infants. However, as compared to intact proteins, extensively hydrolyzed proteins (i.e., proteins having a degree of hydrolysis of about 20% or more) tend to have poor ability to form long term stable emulsions. Additionally, the presence of high levels of insoluble minerals such as calcium salts may also cause a number of stability issues when used in combination with extensively hydrolyzed proteins. As such, manufacturing long term stable liquid concentrated human milk fortifiers including extensively hydrolyzed proteins has proven difficult.

Many liquid human milk fortifiers have been manufactured with stabilizers, such as carrageenan. The stabilizers act to hold the nutrients and insolubles in solution over time and thus improve long term stability of the product. Although stabilizers such as carrageenan have generally proven to retard precipitation of many ingredients in the liquid nutritional formulations, these types of stabilizers are not permitted in infant formulas and human milk fortifiers in many countries around the world. When stabilizers cannot be used in highly concentrated human milk fortifiers, it can be very difficult to produce a long term stable highly concentrated human milk fortifier.

As such, there is a need for highly concentrated liquid human milk fortifiers that have sufficient long term stability and include hypoallergenic proteins, such as extensively hydrolyzed casein proteins. Additionally, it would be very beneficial if the highly concentrated human milk fortifier could be formulated to provide additional nutrients such as lutein to protect pre-term infants from oxidative stress, without unwanted fallout during storage.

### SUMMARY OF THE DISCLOSURE

The present disclosure is directed to long term stable concentrated liquid human milk fortifiers including extensively hydrolyzed casein, a stabilizer system comprised of an octenyl succinic anhydride modified corn starch and a low acyl gellan gum, and carotenoids, such as lutein. The stabilizer system allows for the use of an extensively hydrolyzed casein protein without the associated problems of mineral fallout and poor emulsion stability, and allows for the fortifier, in some embodiments, to be carrageenan-free. In some embodiments, the long term concentrated liquid human milk fortifiers are hypoallergenic.

The present disclosure is specifically directed to a liquid human milk fortifier comprising from about 5% to about 50% by weight extensively hydrolyzed casein protein, on a dry weight basis. The supplemental carotenoids may be provided by a liquid human milk fortifier, containing from about 100 to about 2200 mcg/liter of total carotenoids, wherein the total carotenoids include at least about 50 mcg/liter of lutein, as fed, for the product nutrient levels. The human milk fortifier may further comprise docosahexaenoic acid in a weight ratio of lutein (mcg) to docosahexaenoic acid (mg) of from about 1:2 to about 10:1.

The liquid human milk fortifier also comprises a stabilizer system comprising from about 0.1% to about 3.5% by weight of the concentrated liquid human milk fortifier, or from about 0.8% to about 1.5% by weight of the concentrated liquid human milk fortifier, of an octenyl succinic anhydride modified corn starch, and from about 125 to about 800 ppm low acyl gellan gum.

It has been unexpectedly found that liquid human milk fortifiers can be prepared utilizing a synergistic stabilization system that includes an octenyl succinic anhydride modified corn starch in combination with a low acyl gellan gum. When used together, the octenyl succinic anhydride modified corn starch and low acyl gellan gum provide a stable concentrated liquid human milk fortifier that is emulsion stable and highly resistant to mineral fallout such that a homogeneous and precise delivery of macronutrients and micronutrients can be delivered to human milk and consequently will be precisely delivered to preterm infants.

Additionally, it has further been discovered that liquid human milk fortifiers can advantageously be prepared to include hypoallergenic extensively hydrolyzed casein proteins without disrupting the long term stability or emulsion properties of the fortifier. By utilizing the stabilizer system including the octenyl succinic anhydride modified corn starch and low acyl gellan gum, the concentrated liquid human milk fortifiers may include up to 100% extensively hydrolyzed casein (by weight of the protein component) while maintaining the desired emulsion and stability properties.

Further, liquid human milk fortifiers can be prepared to administer supplemental carotenoids to those infants in need thereof, wherein the supplemental carotenoids comprise lutein, lycopene, beta-carotene, and zeaxanthin. The supplemental carotenoids may be provided by the liquid human milk fortifiers, in quantities from about 100 to about 2200 mcg/liter of total carotenoids, wherein the total carotenoids include at least about 50 mcg/liter of lutein.

It has been found that infant formulas, including liquid human milk fortifiers, may be prepared with lutein concentrations of at least 50 mcg/liter if they are to produce the same plasma lutein concentrations found in breast fed infants, even though human milk itself typically contains no more than about 30 mcg/liter of lutein. The liquid human milk fortifier may further comprise docosahexaenoic acid in a weight ratio of lutein (mcg) to docosahexaenoic acid (mg) of from about 1:2 to about 10:1.

The supplemental carotenoids may also be administered alone or in combination with other ingredients as a preterm infant formula comprising fat, protein, carbohydrate, vitamins, and minerals. The human milk fortifier may further comprise docosahexaenoic acid in a weight ratio of lutein (mcg) to docosahexaenoic acid (mg) of from about 1:2 to about 10:1, including from about 1.5:1 to about 9:1, also including from about 1.7:1 to about 5:1.

When supplemental carotenoids are administered in the form of a preterm infant formula, that formula may be prepared and administered as a sole source, primary source, or supplemental source of nutrition.

Eye and vision development occurs at a rapid rate during the first year of life. At birth, infants can only see high-contrast objects at perhaps 25-30 cm away. During the next 6 months, the infant's retina develops enough to see and discern small details. And as an infant's vision develops, most of which will occur during the first year, the infant becomes better able to learn through visual stimulation now made possible with a newly developed sight. For infants, this visual learning then plays a key role in brain and cognitive development, especially during the first 2-3 years of life.

The concentrated liquid human milk fortifier may also contain 20% by weight of added lutein which may be a combination of free lutein and zeaxanthin from a single source being a crystalline extract of Tagetes erecta in which the free lutein represents from 85% to 95% by weight of the combination and the free zeaxanthin represents from about 5% to about 15% by weight of the combination. The concentrated liquid human milk fortifier may also comprise from about 10% to about 50% by weight extensively hydrolyzed casein protein, on a dry weight basis, and at least 50 mcg/liter lutein, as fed, wherein the concentrated liquid human milk fortifier comprises a stabilizer system comprising from about 0.6% to about 2.0% by weight of an octenyl succinic anhydride modified corn starch and from about 125 to about 800 ppm low acyl gellan gum. The concentrated liquid human milk fortifier may also comprise from about 20% to about 40% by weight extensively hydrolyzed casein protein and from about 0.8% to about 1.5% by weight of an octenyl succinic anhydride modified corn starch with about 150 to about 400 ppm low acyl gellan gum.

The concentrated liquid human milk fortifier may also comprise from about 50 to about 1150 mcg/liter of lutein, as fed. The concentrated human milk fortifier may further contain a combination of free lutein and zeaxanthin from a single source being a crystalline extract of Tagetes erecta in which the free lutein represents from 85% to 95% by weight of the combination and the free zeaxanthin represents from about 5% to about 15% by weight of the combination.

The concentrated liquid human milk fortifier may be aseptically-sterilized and comprise from about 10% to about 50% by weight extensively hydrolyzed casein protein, on a dry weight basis, and at least 50 mcg/liter lutein, wherein the concentrated liquid human milk fortifier comprises a stabilizer system comprising from about 0.6% to about 2.0% by weight of an octenyl succinic anhydride modified corn starch and from about 125 to about 800 ppm low acyl gellan gum.

### DETAILED DESCRIPTION OF THE DISCLOSURE

The concentrated liquid human milk fortifier compositions of the present disclosure generally comprise protein, fat, carbohydrate, OSA-modified starch, low acyl gellan gum, and carotenoids such as lutein. These and other essential or optional elements or limitations of the concentrated liquids and methods of the present disclosure are described in detail hereinafter.

This and all other referenced patents and applications are incorporated herein by reference in their entirety. Where a definition or use of a term in an incorporated reference is inconsistent or contrary to the definition of that term provided herein, the definition of that term provided herein applies and the definition of that term in the reference does not apply.

The term “retort packaging” and “retort sterilizing” are used interchangeably herein, and unless otherwise specified, refer to the common practice of filling a container, most typically a metal can or other similar package, with a nutritional liquid and then subjecting the liquid-filled package to the necessary heat sterilization step, to form a sterilized, retort packaged, nutritional liquid product.

The term “aseptic packaging” as used herein, unless otherwise specified, refers to the manufacture of a packaged product without reliance upon the above-described retort packaging step, wherein the nutritional liquid and package are sterilized separately prior to filling, and then are combined under sterilized or aseptic processing conditions to form a sterilized, aseptically packaged, nutritional liquid product.

The term “infant” as used herein refers generally to individuals less than about 1 year of age, actual or corrected.

The term “preterm infant” as used herein refers to those infants born at less than 37 weeks gestation, have a birth weight of less than 2500 grams, or both.

The term “as-fed basis” as used herein, unless otherwise specified, refers to feeding the infant a suitable nutritional formula in liquid form, which has been properly reconstituted from substances such as liquids, gels, powders and the like; these substances may be reconstituted with human milk or formula, in addition to water, diluted concentrates, and manufactured liquids. In one example, an “as-fed” basis may refer to feeding an infant or pre-term infant the human milk fortifier after mixing the human milk fortifier with human milk in the ratio of 1 part human milk fortifier to 5 parts human milk.

The term “human milk fortifier” as used herein, unless otherwise specified, refers to nutritional compositions for use in combination and admixture with human milk or an infant nutritional formula, preferably human milk. Unless otherwise specified, the term “human milk fortifier” specifically excludes conventional infant formulas that provide the sole or primary source of infant nutrition and are not typically combined and admixed with human milk to supplement human milk feedings. The human milk fortifier of the present invention preferably excludes those compositions derived from concentrated or otherwise modified natural human milk. (See US 2006/0204632, the content of which is herein incorporated by reference in its entirety).

As used herein, all concentrations expressed as either “mcg/liter” or “mg/liter” refer to ingredient concentrations within the described infant formulas as calculated on an as-fed basis of the concentrated human milk fortifier, unless otherwise specified.

The terms “fortifier solids” or “total solids”, unless otherwise specified, are used interchangeably herein and refer to all material components of the compositions of the present disclosure, less water.

The term “hypoallergenic” as used herein means that the concentrated liquid human milk fortifier has a decreased tendency to provoke an allergic reaction in a preterm or term infant as compared to non-hypoallergenic fortifiers.

The term “stable” as used herein means that the concentrated liquid human milk fortifier is resistant to separation and precipitation for time period after manufacture of at least three months, and preferably at least six months.

The terms “fat,” “lipid,” and “oil” as used herein, unless otherwise specified, are used to refer to lipid materials derived or processed from plants. These terms may also include synthetic lipid materials so long as such synthetic materials are suitable for oral administration to humans.

All percentages, parts and ratios as used herein, are by weight of the total composition, unless otherwise specified. All such weights as they pertain to listed ingredients are based on the active level and, therefore, do not include solvents or by-products that may be included in commercially available materials, unless otherwise specified.

Numerical ranges as used herein are intended to include every number and subset of numbers within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth. All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The various embodiments of the concentrated liquid human milk fortifiers of the present disclosure may also be substantially free of any optional or selected essential ingredient or feature described herein, provided that the remaining concentrated liquid human milk fortifier still contains all of the required ingredients or features as described herein. In this context, and unless otherwise specified, the term “substantially free” means that the selected concentrated liquid human milk fortifier contains less than a functional amount of the optional ingredient, typically less than 0.1% by weight, and also including zero percent by weight of such optional or selected essential ingredient.

The concentrated liquid human milk fortifiers and corresponding manufacturing methods of the present disclosure may comprise, consist of, or consist essentially of the essential elements and limitations of the disclosure as described herein, as well as any additional or optional ingredients, components, or limitations described herein or otherwise useful in the concentrated liquid human milk fortifier.

Percentages as relating to the liquid human milk fortifier may be those prior to mixing with breast milk, or other pre-term or full term nutritional formulations.

### Product Form

Concentrated liquid human milk fortifiers have been disclosed, and non-limiting examples are described in PCT WO 2012/061242 (Vurma et al.), and WO 2006/099013 (Baerrett-Reis et al.), the contents of which are incorporated herein by reference in their entirety. The concentrated liquid human milk fortifiers of the present disclosure have a solids content of at least about 20%, or even at least about 25%, including from about 25% to about 45%, and further including from about 29% to about 32%. The concentrated liquid human milk fortifiers are liquids that are capable of being poured directly from a package containing them into human milk or formula.

The concentrated liquid human milk fortifiers are generally formulated to have a caloric density of at least about 1.25 kcal/ml (37 kcal/fl oz), including from about 1.4 kcal/ml (42 kcal/fl oz) to about 5 kcal/ml (149 kcal/fl oz), and also including from about 1.5 kcal/ml (44 kcal/fl oz) to about 2.5 kcal/ml (74 kcal/fl oz), and also including from about 1.9 kcal/ml (56 kcal/fl oz) to about 2.0 kcal/ml (59 kcal/fl oz).

The concentrated liquid human milk fortifiers include packaged compositions further comprising a suitable unit dose package or container. These unit dose packages are single use containers that alone, or in combination with other unit dose packages, provide sufficient human milk fortifier to supplement human milk for immediate use, e.g., preferably within 8-24 hours, more preferably within 0-4 hours, of mixing with human milk.

The amount or volume of concentrated liquid human milk fortifier in each unit dose package includes those embodiments in which the package contains an amount suitable to prepare an infant's next feeding. These unit dose packages typically contain sufficient fortifier to provide from about 0.5 g to about 10 g of fortifier solids, more typically from about 0.8 g to about 7.5 g of fortifier solids, and even more typically from about 0.85 g to about 6.0 g, of fortifier solids.

The concentrated liquid human milk fortifiers of the present disclosure are preferably formulated so as to provide fortified human milk having an osmolality of less than about 500 mOsm/kg water, preferably from about 300 mOsm/kg water to about 400 mOsm/kg water. Based on the disclosure herein, one skilled in the art can readily formulate the concentrated liquid human milk fortifier with the appropriate carbohydrate sources and corresponding DE (dextrose equivalence) values to obtain or otherwise provide for the targeted osmolality of the human milk fortifier when combined with human milk.

The term “unit dose” as used herein refers to individual, single-use, packages of concentrated liquid human milk fortifier containing an amount of human milk fortifier that can be used in a preparation of an infant feeding. The amount of fortified human milk prepared for a premature infant, for example, typically ranges from 25 ml to 150 ml a day. Consequently, a single unit dose is the appropriate amount of fortifier solids to fortify a 25 ml preparation. Multiple packages can be used to prepare larger feeding volumes, especially for term infants.

### Extensively Hydrolyzed Casein Protein

The concentrated liquid human milk fortifiers of the present disclosure contain hypoallergenic extensively hydrolyzed casein as a protein source. Generally, the concentrated liquid human milk fortifiers will include at least about 35%, including at least about 50%, including at least about 60%, including at least about 75%, including at least about 90% and further including about 100% extensively hydrolyzed casein, by total weight of protein in the concentrated human milk fortifier.

In one desirable embodiment of the present disclosure, the concentrated liquid human milk fortifier includes 100% extensively hydrolyzed casein, by total weight of the protein in the concentrated human milk fortifier. In this desirable embodiment, the concentrated liquid human milk fortifier is hypoallergenic. In some embodiments, the concentrated liquid human milk fortifier will include from about 10%-40%, 20%-50%, 35%-100%, 50%-100%, further including from about 75%-100% extensively hydrolyzed casein, by total weight of protein in the concentrated human milk fortifier. As discussed further below, in some embodiments of the present disclosure, the concentrated liquid human milk fortifiers of the present disclosure may optionally include other hypoallergenic or non-hypoallergenic proteins in addition to the extensively hydrolyzed casein protein.

Extensively hydrolyzed casein proteins suitable for use in the concentrated liquid human milk fortifiers of the present disclosure include those having a degree of hydrolysis of from about 10% to about 70%, including from about 30% to about 60%, and further including from about 40% to about 60%. Generally, the extensively hydrolyzed casein has a ratio of total amino nitrogen (AN) to total nitrogen (TN) of from about 0.2 AN to 1.0 TN to about 0.4 AN to about 0.8 TN. Suitable commercially available extensively hydrolyzed caseins will generally have a protein level in the ingredient of from about 50% to about 95%, including from about 70% to about 90%. One suitable commercially available extensively hydrolyzed casein is Dellac CE90, which is a spray dried powder casein hydrolysate (Friesland Campina Domo, Amersfoort, The Netherlands).

### Stabilizer System

The concentrated liquid human milk fortifiers of the present disclosure include a synergistic two component stabilizer system. The first component is an octenyl succinic anhydride (OSA) modified starch, such as an octenyl succinic anhydride (OSA) modified corn starch. The second component is a low acyl gellan gum. These two components act in a synergistic manner to stabilize the concentrated liquid human milk fortifier emulsion and retard the precipitation of nutrients therefrom.

The OSA-modified starch, including the desirable OSA-modified corn starch, is generally prepared by esterifying a dextrinized, ungelatinized waxy corn starch with 1-octenyl succinic anhydride. Methods of this type are well known in the art. One suitable commercially available OSA-modified corn starch is Uni-Pure IMF 2332 (Ingredion Incorporated, Westchester, Ill.).

The OSA-modified starch is present in the concentrated liquid human milk fortifier in an amount of from about 0.1% to about 3.5%, including from about 0.6% to about 2.0%, including from about 0.8% to about 1.5%, and further including about 1.2% by weight of the concentrated liquid human milk fortifier.

The low acyl gellan gum (also known as and commonly referred to as deacylated gellan gum) may be a water-soluble polysaccharide produced by fermentation of a pure culture of Sphingomonas elodea. As used herein, “low acyl” means that the gellan gum has been treated such that it forms firm, non-elastic, brittle gels, that are heat stable, as compared to “high acyl” which forms soft, very elastic, non-brittle gels. One suitable commercially available low acyl gellan gum is Kelcogel F (CP Kelco U.S. Inc., Atlanta Ga.).

The low acyl gellan gum is present in the concentrated liquid human milk fortifier in an amount from greater than 125 ppm to about 800 ppm, including from about 150 ppm to about 400 ppm, including from about 200 ppm to about 300 ppm and further including about 200 ppm.

### Macronutrients

The concentrated liquid human milk fortifiers of the present disclosure comprise carbohydrate, fat, and protein macronutrients of sufficient types and amounts, that when used in combination with human milk or other infant feeding formula, they help meet the nutritional needs of the infant, especially the premature infant. The concentration of these macronutrients in the various embodiments of the present disclosure includes the ranges described hereinafter.

### Protein

The concentrated liquid human milk fortifiers of the present disclosure comprise a protein suitable for use in infants, especially preterm infants, at concentrations ranging from about 5% to about 50%, including from about 20% to about 40%, including from about 5% to about 30%, including from about 10% to about 25%, and also including from about 15% to about 25%, on a dry weight basis. In some embodiments, the protein may be at a concentration of less than 10%, on a dry weight basis. In some desirable embodiments, the protein concentration may be from about 7 to about 15 grams, including from about 9 to about 12 grams of protein per 100 grams of final liquid product.

As noted above, the protein component of the concentrated liquid human milk fortifiers of the present disclosure is comprised of extensively hydrolyzed casein. In a particularly desirable embodiment of the present disclosure, the protein component of the concentrated human milk fortifier is entirely comprised of extensively hydrolyzed casein. In embodiments wherein additional proteins sources (i.e., one or more protein sources in addition to the extensively hydrolyzed protein source) are to be used in the concentrated liquid human milk fortifier in addition to the extensively hydrolyzed casein (i.e., the concentrated human milk fortifier protein component is not 100% extensively hydrolyzed casein), the fortifier may still be made hypoallergenic by including additional hypoallergenic proteins such as soy protein hydrolysate, whey protein hydrolysate, rice protein hydrolysate, potato protein hydrolysate, fish protein hydrolysate, egg albumen hydrolysate, gelatin protein hydrolysate, pea protein hydrolysate, bean protein hydrolysate, combinations of animal and vegetable protein hydrolysates, and combinations thereof.

In this context, the terms “protein hydrolysates” and “hydrolyzed protein” are used interchangeably herein and include extensively hydrolyzed proteins, wherein the degree of hydrolysis is most often at least about 10%, including from about 10% to about 80%, and also including from about 30% to about 80%, even more preferably from about 40% to about 60%. The degree of hydrolysis is the extent to which peptide bonds are broken by a hydrolysis method. The degree of protein hydrolysis for purposes of characterizing the extensively hydrolyzed protein component of these embodiments may be readily determined by one of ordinary skill in the formulation arts by quantifying the amino nitrogen to total nitrogen ratio (AN/TN) of the protein component of the selected formulation. The amino nitrogen component is quantified by USP titration methods for determining amino nitrogen content, while the total nitrogen component is determined by the Tecator Kjeldahl method, all of which are well known methods to one of ordinary skill in the analytical chemistry art.

In other embodiments of the present disclosure, the concentrated liquid human milk fortifier, in addition to the extensively hydrolyzed protein, may include an additional non-hypoallergenic protein source including for example, partially hydrolyzed or non-hydrolyzed (intact) protein, and can be derived from any known or otherwise suitable source such as milk (e.g., casein, whey, lactose-free milk protein isolates), animal (e.g., meat, fish), cereal (e.g., rice, corn), vegetable (e.g., soy, pea, bean), or combinations thereof. The protein can include, or be entirely or partially replaced by, free amino acids known or otherwise suitable for use in nutritional products, non-limiting examples of which include L-alanine, L-arginine, L-asparagine, L-aspartic acid, L-carnitine, L-cystine, L-glutamic acid, L-glutamine, glycine, L-histidine, L-isoleucine, L-leucine, L-lysine, L-methionine, L-phenylalanine, L-proline, L-serine, L-taurine, L-threonine, L-tryptophan, L-tyrosine, L-valine, and combinations thereof.

### Carbohydrate

The concentrated liquid human milk fortifiers of the present disclosure comprise a carbohydrate suitable for use in infants, especially preterm infants, at concentrations most typically ranging up to about 75% by weight on a dry weight basis, including from about 5% to about 50%, and also including from about 20% to about 40% by weight on a dry weight basis.

Carbohydrates suitable for use in the concentrated liquid human milk fortifiers may include hydrolyzed or intact, naturally and/or chemically modified, starches sourced from corn, tapioca, rice or potato, in waxy or non-waxy forms.

Other non-limiting examples of suitable carbohydrate sources include hydrolyzed cornstarch, maltodextrin (i.e. non-sweet, nutritive polysaccharide having a DE value less than 20), corn maltodextrin, glucose polymers, sucrose, corn syrup, corn syrup solids (i.e., polysaccharide having a DE value greater than 20), glucose, rice syrup, fructose, high fructose corn syrup, indigestible oligosaccharides such as fructooligosaccharides (FOS), and combinations thereof. The carbohydrates may comprise lactose or can be substantially free of lactose.

One embodiment of the present disclosure includes a non-reducing carbohydrate component, which may represent from about 10% to 100%, including from about 80% to 100%, and also including 100%, by weight of the total carbohydrate in the concentrated liquid human milk fortifier. The selection of a non-reducing carbohydrate may enhance the product stability and is generally better tolerated by infants, especially premature infants. Non-limiting examples of non-reducing carbohydrates include sucrose or other carbohydrates that do not readily oxidize or react with Tollen's, Benedict's, or Fehling's reagents. The present invention therefore includes those embodiments comprising a carbohydrate component, wherein the carbohydrate component comprises a mono- and/or disaccharide such that at least about 50%, including from about 80% to 100%, and also including 100%, of the mono- and/or disaccharide is a non-reducing carbohydrate.

### Fat

The concentrated liquid human milk fortifiers of the present disclosure also comprise a fat component suitable for use in infants, especially preterm infants, at concentrations most typically ranging up to about 40% by weight on a dry weight basis, including from about 10% to about 40%, and also including from about 15% to about 37%, and also including from about 18% to about 30%, by weight on a dry weight basis.

Fats suitable for use in the concentrated liquid human milk fortifiers of the present disclosure may include coconut oil, soy oil, corn oil, olive oil, safflower oil, high oleic safflower oil, MCT (medium chain triglycerides) oil, sunflower oil, high oleic sunflower oil, structured triglycerides, palm oil, palm kernel oil, palm olein, canola oil, marine oil, cottonseed oil, and combinations thereof.

Suitable fats for use in the concentrated liquid human milk fortifiers include emulsifiers to help the various fortifier components readily disperse when combined with human milk. Non-limiting examples of suitable emulsifiers include soya bean lecithin, polyoxythylene stearate, polyoxyethylene sorbitan mono-oleate, polyoxyethylene sorbitan monopalmitate, polyoxyethylene sorbitan monostearate, ammonium phosphatides, polyoxyethylene sorbitan monolaurate, citric acid esters of mono and diglycerides of fatty acids, tartaric acid esters of mono and diglycerides of fatty acids, and combinations thereof. Natural soy lecithin is especially useful in this respect.

The fat component of the concentrated liquid human milk fortifier may therefore optionally include any emulsifier suitable for use in infant nutritional products. Emulsifier concentrations in these products may range up to about 10%, including from about 1% to about 10%, even more typically from about 1.5% to about 5%, by weight of the total fat component.

Another aspect of the present disclosure includes those embodiments in which the weight ratio of fat to protein in the concentrated liquid human milk fortifier is at least about 0.3, including from about 0.4 to about 5, and also including from about 2 to about 4. These ratios may be helpful in further stabilizing the concentrated liquid human milk fortifier.

The concentrated liquid human milk fortifiers of the present disclosure also include those embodiments that comprise as part of the fat component one or more of arachidonic acid, docosahexaenoic acid, or combinations thereof, alone or in further combination with linoleic acid, linolenic acid, or both.

### Supplemental Carotenoids

Eye and vision development occurs at a rapid rate during the first year of life. At birth, infants can only see high-contrast objects at perhaps 25-30 cm away. During the next 6 months, the infant's retina develops enough to see and discern small details. And as an infant's vision develops, most of which will occur during the first year, the infant becomes better able to learn through visual stimulation now made possible with a newly developed sight. For infants, this visual learning then plays a key role in brain and cognitive development, especially during the first 2-3 years of life.

By promoting retinal health and vision development in infants, the infant formulas of the present invention may also help children develop their ability to visually learn as soon as possible, and to potentially accelerate brain and cognitive development associated with early visual stimulation through the developing retina of the eye. The infant formulas described herein are therefore useful in promoting vision development in infants, and consequently are useful in promoting secondary benefits such as associated cognitive and brain development through early visual stimulation. It is also useful in preterm infants to help accelerate the development of normal vision, to thus reduce the time needed to catch-up with development milestones set by their term infant counterparts.

The methods described herein are particularly useful to reduce the risk or severity of retinopathy of prematurity. This condition often affects preterm infants and is most commonly characterized by abnormal development of retinal vessels in the eye possibly as a result of oxidative stress secondary to high oxygen tension. This affliction can occur to varying degrees, from slight vessel involvement with minimal or no impact on vision, to partial or complete retinal detachment leading to blindness. Historically, therapy for appropriate cases included laser treatment as well as cryotherapy.

In accordance with the methods herein, the supplemental carotenoids, including lutein, may be administered to those infants with a measured Raman Count of less than about 20,000, including from about 100 to about 15,000, also including from about 400 to about 10,000, wherein all such ranges are proceeded by administration of supplemental carotenoids in amounts sufficient to increase the Raman Count in the infant, typically by at least about 5%, including from about 20% to about 500%. Raman counts correlate with serum and tissue carotenoid levels.

The supplemental carotenoids (e.g., lutein, lycopene, beta-carotene, and zeaxanthin) for use herein may be provided or otherwise administered in any form suitable for use in preterm infants and infants.

### Lutein

The term “lutein” as used herein, unless otherwise specified, refers to one or more of free lutein, lutein esters, lutein salts, or other lutein derivatives or related structures as described or otherwise suggested herein. Lutein or lutein sources suitable for use in the infant formulas of the present invention include free lutein as well as esters, salts or other derivatives or related structures thereof, including those that conform to the formula:

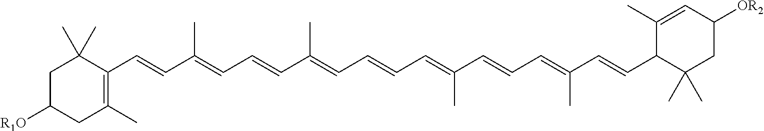

The above formula includes the general structure of lutein and related derivatives or structures. Free lutein, for example, corresponds to the formula wherein R1 and R2 are both hydrogen, and includes cis and trans isomers thereof as well as salts thereof, e.g., sodium, potassium.

Lutein esters suitable for use herein include any lutein ester of the above formula wherein R₁ and R₂ are the same or different, and are nutritionally acceptable monovalent salts, hydrogen or an acyl residue of a carboxylic acid, provided that at least one of R₁ or R₂ is an acyl residue of a carboxylic acid. Suitable lutein esters include, as well, both cis and trans isomers. The R₁ and R₂ moieties are residues of a saturated or unsaturated C₁ to C₂₂ fatty carboxylic acids, non-limiting examples of which include formic, acetic, propionic, butyric, valeric, caproic, caprylic, capric, lauric, myristic, palmitic, stearic, and oleic acids.

Lutein for use herein includes any natural or synthetic source that is known for or is otherwise an acceptable source for use in oral nutritionals, including infant formulas. Lutein sources can be provided as individual ingredients or in any combination with other materials or sources, including sources such as multivitamin premixes, mixed carotenoid premixes, pure lutein sources, and inherent lutein from other fat or oil components in the infant formula. The lutein concentrations and ratios as described herein are calculated based upon added and inherent lutein sources. The infant formulas, as constituted from human milk fortifier of the present invention, preferably comprise at least about 25%, more preferably from about 50% to about 95%, by weight of total lutein as added lutein, the remainder being inherent lutein that accompanies added fats and oils. Lutein concentrations, on an as-fed basis may be at least about 50 mcg/liter, or from about 100 mcg/liter to about 250 mcg/liter, or from about 50 to about 1150 mcg/liter, after reconstitution, in order to duplicate plasma lutein concentrations found in exclusively breast fed infants. Lutein concentrations in the concentrated human milk fortifier may contain a minimum lutein concentration of at least about 170 mcg/liter or about 0.85 mcg of lutein per 5 mL pouch. In certain embodiments, the lutein concentration in the concentrated human milk fortifier may be about 170 mcg/liter to about 1360 mcg/liter.

Each of the carotenoids for use herein may be obtained from any known or otherwise suitable material source for use in infant nutritional formulas, and each can be provided individually, or all together, or in any combination and from any number of sources, including sources such as multivitamin premixes containing other vitamins or minerals in combination with one or more of the other carotenoids as described herein. Non-limiting examples of some suitable carotenoid sources include LycoVit® synthetic lycopene dispersion in vegetable oil provided by BASF (Mount Olive, N.J.), Lyc-O-Mato® tomato extract in oil, powder, or bead form provided by LycoRed Natural Products Industries, Ltd. (Bear Sheba, Israel), water-dispersible and oil soluble lycopene provided by DSM Nutritional Products (Basel, Switzerland), FloraGLO® brand free lutein provided by Kemin Foods (Des Moines, Iowa), Xangold® Lutein Esters provided by Cognis (Cincinnati, Ohio), and beta-carotene provided by BASF (Mount Olive, N.J.).

Non-limiting examples of some suitable lutein sources for use herein include FloraGLO® Crystalline Lutein, available from Kemin Foods (Des Moines, Iowa); and Xangold® Lutein Esters provided by Cognis (Cincinnati, Ohio).

The infant formulas for use herein include those comprising a single source combination of free lutein and zeaxanthin, in a purified crystalline extract from the marigold flower (Tagetes erecta), wherein the free lutein represents from 85% to 95% by weight of the combination and the zeaxanthin represents from about 5% to about 15% by weight of the combination. A lutein-zeaxanthin combination is available from Kemin Foods (Des Moines, Iowa) under the FloraGLO® brand.

### Docosahexaenoic Acid (DHA)

The human milk fortifier for use herein may comprise docosahexaenoic acid, in a concentration range from at least about 30 mg/liter of docosahexaenoic acid, wherein the weight ratio of lutein (mcg) to docosahexaenoic acid (mg) is from about 1:2 to about 10:1.

Docosahexaenoic acid (DHA) is an organic carboxylic acid having a chain length of 22 carbons with 6 double bonds beginning with the third carbon from the methyl end (22:6 n-3). Any source of docosahexaenoic acid is suitable for use herein provided that such a source is also known for or otherwise suitable for use in infant formulas and is compatible with the other selected ingredients in the formula.

Docosahexaenoic acid concentrations in the human milk fortifier may be selected so that the resulting weight ratio of lutein to docosahexaenoic acid falls within the range as defined herein. Such concentrations most typically range from at least about 30 mg/liter, including from about 36 to 360 mg/liter, including from about 72 to about 280 mg/liter, and also including from about 150 to about 230 mg/liter of DHA, as calculated on an as-fed basis, (as fed after mixing 1 part human milk fortifier with 5 parts human milk). A minimum DHA concentration may be about 174.40 mg/liter. The weight ratio of lutein (mcg) to docosahexaenoic acid (mg) is from about 1:2 to about 10:1. The human milk fortifier may contain minimum DHA levels of about 753 mg/liter.

The docosahexaenoic acid may be added to the human milk fortifier as free fatty acids or as compounds or materials that can otherwise provide a source of such free fatty acids upon or following administration to the infant, including non-egg phospholipids and glyceride esters (mono-, di-, tri-) of docosahexaenoic acids. Polyunsaturated fatty acids and sources thereof are described in U.S. Pat. No. 6,080,787 (Carlson, et al.) and U.S. Pat. No. 6,495,599 (Auestad, et al.), which descriptions are incorporated by reference herein. Some non-limiting examples of suitable docosahexaenoic acid sources include fish oils, algal oils, other single cell oils, and combinations thereof

The human milk fortifier may further comprise, in addition to the docosahexaenoic acid as described herein, other long chain polyunsaturated fatty acids such as arachidonic acid (20:4 n-6), eicosapentaenoic acid or EPA (20:5 n-3), linoleic acid (18:2 n-6), γ-linolenic acid or GLA (18:3 n-6), α-linolenic acid (18:3 n-3), dihomo-γ-linolenic or DHGLA (20:3 n-6), α-linolenic (18:3 n-3), stearidonic acid (18:4 n-3), and combinations thereof. Such optional long chain polyunsaturated fatty acids may likewise be formulated into the infant formula as free fatty acids or as compounds or materials that can otherwise provide a source of such free fatty acids upon or following administration to the infant, including non-egg phospholipids and glyceride esters (mono-, di-, tri-) of docosahexaenoic acids.

### Vitamins and Minerals

The concentrated liquid human milk fortifiers of the present disclosure may further comprise any of a variety of vitamins, non-limiting examples of which include vitamin A, vitamin D, vitamin E, vitamin K, thiamine, riboflavin, pyridoxine, vitamin B12, niacin, folic acid, pantothenic acid, biotin, vitamin C, choline, inositol, salts and derivatives thereof, and combinations thereof

The concentrated liquid human milk fortifiers may also further comprise any of a variety of minerals known or otherwise suitable for us in infant or other nutritional formulas, non-limiting examples of which include phosphorus, magnesium, calcium as described hereinbefore, zinc, manganese, copper, iodine, sodium, potassium, chloride, selenium, and combinations thereof

The concentrated liquid human milk fortifiers of the present disclosure include those embodiments comprising per 100 kcal of fortifier solids one or more of the following: vitamin A (from about 250 to about 6500 IU), vitamin D (from about 40 to about 1200 IU), vitamin K, vitamin E (at least about 0.3 IU), vitamin C (at least about 8 mg), thiamine, vitamin B12, niacin, folic acid, pantothenic acid, biotin, choline (at least about 7 mg), and inositol (at least about 2 mg).

The concentrated liquid human milk fortifiers also include those embodiments comprising per 100 kcal of the fortifier solids one or more of the following: calcium (at least about 50 mg), phosphorus (at least about 25 mg), magnesium (at least about 6 mg), iodine, zinc (at least about 0.5 mg), copper, manganese, sodium (from about 20 to about 60 mg), potassium (from about 80 to about 200 mg), chloride (from about 55 to about 150 mg) and selenium (at least about 0.5 mcg).

### Other Optional Ingredients

The concentrated liquid human milk fortifiers of the present disclosure may further optionally comprise other ingredients that may modify the physical, chemical, aesthetic or processing characteristics of the formulas or serve as pharmaceutical or additional nutritional components when used in the targeted population. Many such optional ingredients are known for use in food and nutritional products, including infant formulas, and may also be used in the concentrated liquid human milk fortifiers of the present disclosure, provided that such optional materials are compatible with the essential materials described herein, are safe and effective for their intended use, and do not otherwise unduly impair product performance.

Non-limiting examples of such optional ingredients include preservatives, anti-oxidants, various pharmaceuticals, buffers, other carotenoids, colorants, flavors, nucleotides and nucleosides, thickening agents, prebiotics, probiotics, sialic acid-containing materials, and other excipients or processing aids.

### Aseptic Packaging

The concentrated liquid human milk fortifiers of the present disclosure may be sterilized and aseptically packaged. The aseptic packaging can be accomplished using any of a variety of techniques well known to those of ordinary skill in the formulation art, so long as the heat treatment is sufficient to achieve long term shelf stability of the concentrated liquid. In one specific example, an aseptic process is utilized that includes a high temperature short time (HTST) processing step (i.e., about 74° C. for about 16 seconds) or an ultra high temperature (UHT) processing step (i.e., about 135° C. for about 5 seconds).

A typical aseptic process in accordance with the present disclosure involves the preparation of a slurry from one or more fluid combinations that may contain water and one or more of the following: carbohydrates, extensively hydrolyzed casein protein, fats, vitamins and minerals. This slurry is typically emulsified, deaerated, homogenized and cooled to form a sterilized formula, and then aseptically packaged to form a sterilized, aseptically packaged concentrated liquid human milk fortifier. Various other solutions may be added to the slurry at most any time before, during, or after processing.

Suitable aseptic packaging techniques include any of the well known aseptic packaging methods disclosed in the formulation arts for preparing a nutritional formulation, all of which are generally directed to the sealing or filling of a sterilized liquid into a sterilized, air-tight container. Many variations on the basic method exist and are well known to those of ordinary skill in the formulation art, non-limiting examples of which are described in U.S. Pat. No. 6,096,358 (Murdick et al); U.S. Pat. No. 6,227,261 (Das et al); and U.S. Pat. No. 6,371,319 (Yeaton et al), which descriptions are incorporated herein by reference.

The aseptically packaged embodiments of the present disclosure may include any container or package suitable for use with liquid human milk fortifiers and also capable of withstanding aseptic processing conditions (e.g., high temperature sterilization). Non-limiting examples of such containers include single or multi use bags, plastic bottles or containers, pouches, metal cans glass bottles, foil or other flexible pouches, syringes, vials, or any other container meeting the above-described criteria.

The aseptically packaged container for these embodiments is typically sterilized prior to being filled with its sterilized contents. The container is most typically sterilized by the application of hydrogen peroxide or other suitable disinfectant to the inside surface of the container. The hydrogen peroxide or other disinfectant is often applied in an atomized mist. After a disinfectant is applied, the container may be transported along a conveyor system during which time the container may be subjected to one or more sprayings of hot sterilized air, preferably hot, sterilized, dry air. The container is then preferably injected with nitrogen gas. The aseptically prepared container is then aseptically filled with sterilized product and sealed.

For aseptic packaging, the concentrated liquid human milk fortifier is typically heat treated with a high temperature short time (HTST) process or an ultra high temperature (UHT) process to sufficiently reduce the bioburden to allow the products to remain commercially sterile over an extended shelf-life of the finished product exceeding about 12 months. The treated formula is then homogenized at 1000 psi or higher and aseptically packaged.

In an alternative embodiment, the concentrated human milk fortifiers of the present disclosure may also be sterilized and retort packaged utilizing conventional means known in the art.

### Method of Use

The concentrated liquid human milk fortifier of the present disclosure is used in combination with human milk or other suitable infant formula, wherein the resulting fortified human milk or fortified infant formula has an osmolality suitable for oral administration to an infant. As noted, the osmolality will most typically be less than about 500 mOsm/kg water, more typically from about 300 mOsm/kg water to about 400 mOsm/kg water.

The concentrated liquid human milk fortifier of the present disclosure may be added directly to human milk in a volume to volume ratio of from about 1:3 to about 1:9, including from about 1:3.5 to about 1:7, and also including from about 1:4 to about 1:6. The ratio is ultimately selected based primarily upon the ingredients and osmolality of the concentrated liquid human milk fortifier and in view of the particular nutritional needs of the infant. The concentrated liquid human milk fortifier may be added directly to every feeding or to a sufficient number of feedings (e.g., once or twice daily) to provide optimal nutrition in view of the particular nutritional needs of the infant.

Human milk or other infant formula, after fortification with the concentrated liquid human milk fortifier will most typically have a caloric density ranging from about 19 kcal/fl oz (0.64 kcal/ml) to about 26.7 kcal/fl oz (0.9 kcal/ml), with the 22-25 kcal/fl oz formulations (0.74-0.84 kcal/ml) being more useful in preterm infants, and the 19-21 kcal/fl oz (0.64-0.71 kcal/ml) formulations more useful for term infants.

The methods of the present disclosure therefore include a method of providing nutrition to infants, especially preterm infants, said method comprising the addition of the concentrated liquid human milk fortifier to human milk or other infant feeding composition, followed by the administration of the fortified human milk or feeding composition to the infant.

The methods of the present disclosure also include a method of reducing the risk of microbial contamination, including Cronobacter (Enterobacter) sakazakii contamination, of term or preterm infant feeding compositions, said method comprising the direct addition of the concentrated liquid human milk fortifier to human milk or other infant feeding composition followed by the administration of the fortified composition to the infant.

### Manufacture

The concentrated liquid human milk fortifiers of the present disclosure may be prepared in accordance with the methods described hereinafter, which methods are described in association with the exemplified embodiments (see Examples). In one embodiment, the concentrated liquid human milk fortifier is prepared by solubilizing and combining/mixing ingredients into a homogeneous aqueous mixture which is subjected to a sufficient thermal treatment and aseptic filling to achieve long term physical and microbial shelf stability.

To begin the manufacturing process, macronutrients (carbohydrate, protein, fat, and minerals) are combined in several slurries together and with water. This blend is subjected to an initial heat treatment and then tested to verify proper nutrient levels. Additional detail on this process is provided in the following paragraphs.

An intermediate aqueous carbohydrate-mineral (CHO-MN) slurry is prepared by heating an appropriate amount of water. With agitation, the following soluble ingredients are added: maltodextrin, potassium citrate, magnesium chloride, potassium chloride, sodium chloride, and choline chloride. The carbohydrate-mineral slurry is held at elevated temperature under agitation until added to the blend.

An intermediate oil slurry is prepared by heating MCT oil and coconut oil to an elevated temperature and then adding distilled monoglycerides with agitation for a minimum 10 minutes in order to allow the ingredients to dissolve. Soy oil, vitamin A palmitate, vitamin D3, dl-alpha-tocopheryl-acetate, phylloquinone, ARA, DHA, and mixed carotenoids are then added with agitation to the oil blend. Insoluble mineral calcium source, ultra micronized tricalcium phosphate, is added to the oil. Gellan gum and OSA-modified starch are then added to the oil blend with proper agitation. The oil blend slurry is maintained at an elevated temperature under agitation until added to the blend.

The blend is prepared by combining the ingredient water, casein hydrolysate, all of the CHO-MN slurry and whole oil blend slurry. The blend is maintained at about 49° C. for a period of time not to exceed two hours before further processing. The blend is then homogenized using one or more in-line homogenizers at pressures from 1000-4000 psig with or without a second stage homogenization from 100-500 psig followed by heat treatment using a UHTST (ultrahigh temperature short time, about 144-147° C. for 1-30 seconds) process. After the appropriate heat treatment, the batch is cooled in a plate cooler to about 1-7° C. and then transferred to a refrigerated holding tank, where it is subjected to analytical testing.

The next step in the manufacturing process involves adding vitamins, trace minerals and water in order to reach the final target total solids and vitamin/mineral content. The final batch is filled into a suitable container under aseptic conditions or treated with a terminal sterilization process so the product will be stable at room temperature for an extended shelf-life. Additional detail on this process is provided in the following paragraphs.

A trace mineral/vitamin/nutrient solution (STD 1) is prepared by heating water to about 25-38° C. and adding the following ingredients with agitation: potassium citrate, ferrous sulfate, zinc sulfate, copper sulfate, manganese sulfate, sodium selenate, pyridoxine hydrochloride, riboflavin, thiamine hydrochloride, cyanocobalamin, folic acid, calcium pantothenate, niacinamide, biotin, m-inositol, nucleotide/choline premix, L-carnitine, L-Leucine, and L-tyrosine.

A vitamin C solution (STD2) is prepared by adding ascorbic acid to water solution with agitation.

All STD1 and STD2 solutions are then added to the refrigerated batch, with agitation. The appropriate amount of ingredient dilution water is then added to the batch to achieve a target total solids level of 28.0-32.0%. The final batch is then subjected to appropriate thermal treatment and filled into a suitable container under an aseptic conditions and processes.

The concentrated liquid human milk fortifiers of the present disclosure may, of course, be manufactured by other known or otherwise suitable techniques not specifically described or shown herein without departing from the spirit and scope of the present disclosure. The present embodiments are, therefore, to be considered in all respects as illustrative and not restrictive and that all changes and equivalents also come within the description of the present disclosure. The following non-limiting examples will further illustrate the formulations and methods of the present disclosure.

### Example

The following example illustrates a specific embodiment of the concentrated liquid human milk fortifiers products of the present disclosure. This example is given solely for the purpose of illustration and are not to be construed as limitations of the present disclosure, as many variations thereof are possible without departing from the spirit and scope of the disclosure. All exemplified amounts are weight percentages based upon the total weight of the formulation, unless otherwise specified.

As used herein, all concentrations expressed as either “mcg/liter” or “mg/liter” refer to ingredient concentrations within the described infant formulas as calculated on an as-fed basis, unless otherwise specified.

In Example 1, the concentrated liquid human milk fortifier is prepared in accordance with the present disclosure. The ingredients for the concentrated liquid human milk fortifier are shown in the following table.

Example 1

| | Amount per | |
|---|---|---|
| Ingredients | 1000 lb | UOM |
| Ingredient Water | q.s. | |
| Casein Hydrolysate | 110.6 | lb |
| Maltodextrin | 108.2 | lb |
| MCT Oil | 18.0 | lb |
| Tricalcium Phosphate | 15.3 | lb |
| Modified Corn Starch | 12.0 | lb |
| Soy Oil | 11.3 | lb |
| Coconut Oil | 6.9 | lb |
| Potassium Citrate | 5.6 | lb |
| Magnesium Chloride | 3.4 | lb |
| Ascorbic Acid | 3.3 | lb |
| M. Alpina Oil (ARA) | 2.6 | lb |
| C. Cohnii Oil (DHA) | 2.3 | lb |
| Potassium Chloride | 1.5 | lb |
| Sodium Chloride | 431.4 | g |
| Distilled monoglycerides | 390.1 | g |
| M-Inositol | 200.0 | g |
| Choline Chloride | 160.0 | g |
| Zinc Sulfate | 130.3 | g |
| Niacinamide | 127.3 | g |
| dl-Alpha-Tocopheryl Acetate | 108.7 | g |
| L-Carnitine | 100.00 | g |
| Gellan Gum | 99.8 | g |
| Calcium Pantothenate | 60.0 | g |
| Ferrous Sulfate | 52.0 | g |
| Vitamin A Palmitate | 25.8 | g |
| Riboflavin | 15.0 | g |
| Thiamin Hydrochloride | 11.0 | g |
| Pyridoxine Hydrochloride | 8.9 | g |
| Vitamin D₃ | 6.7 | g |
| Cupric Sulfate | 6.0 | g |
| Lutein, 20% in safflower oil | 3.2 | g |
| Folic Acid | 1.4 | g |
| Beta Carotene | 940 | mg |
| Biotin | 860 | mg |
| Manganese Sulfate | 840 | mg |
| Phylloquinone | 285 | mg |
| Sodium Selenate | 44 | mg |
| Cyanocobalamin | 40 | mg |
| Potassium Hydroxide | q.s. | |

The concentrated liquid human milk fortifier is prepared by solubilizing and combining/mixing ingredients into a homogeneous aqueous mixture which is subjected to a sufficient thermal treatment and aseptic filling to achieve long term physical and microbial shelf stability.

To begin the manufacturing process, macronutrients (carbohydrate, protein, fat, and minerals) are combined in several slurries together and with water. This blend is subjected to an initial heat treatment and then tested to verify proper nutrient levels. Additional detail on this process is provided in the following paragraphs.

An intermediate aqueous carbohydrate-mineral (CHO-MN) slurry is prepared by heating appropriate amount of water to about 60-70° C. With agitation, the following soluble ingredients are added: maltodextrin, potassium citrate, magnesium chloride, potassium chloride, sodium chloride, and choline chloride. The carbohydrate-mineral slurry is held at 54-66° C. under agitation until added to the blend.

An intermediate oil slurry is prepared by heating MCT oil and coconut oil to about 66-77° C. and then adding distilled monoglycerides with agitation for a minimum of 10 minutes in order to the ingredient to dissolve. Soy oil, vitamin A palmitate, vitamin D3, di-alpha-tocopheryl-acetate, phylloquinone, ARA-containing oil, DHA-containing oil, beta carotene and lutein are then added with agitation to the oil blend. Insoluble mineral calcium source, and ultra micronized tricalcium phosphate is added to the oil. Gellan gum and OSA-modified starch are then added to the oil blend with proper agitation. The oil blend slurry is maintained at about 54-66° F. under agitation until added to the blend.

The blend is prepared by combining the ingredient water, casein hydrolysate, all of the CHO-MN slurry and whole oil blend slurry. The blend is maintained at about 49° C. for a period of time not to exceed two hours before further processing.

The blend is then homogenized using one or more in-line homogenizers at pressures from 1000-4000 psig with or without a second stage homogenization from 100-500 psig followed by heat treatment using a UHTST (ultrahigh temperature short time, 144-147° C. for 5-15 seconds) process. After the appropriate heat treatment, the batch is cooled in a plate cooler to 1-° C. and then transferred to a refrigerated holding tank, where it is subjected to analytical testing.

The next step in the manufacturing process involves adding vitamins, trace minerals, other ingredients, and water in order to reach the final target total solids and vitamin/mineral contents. The final batch is filled into a suitable container under aseptic conditions or treated with a terminal sterilization process so the product will be stable at room temperature for an extended shelf-life. Additional detail on this process is provided in the following paragraphs.

A trace mineral/vitamin/nutrient solution (STD 1) is prepared by heating water to about 25-38° C. and adding the following ingredients with agitation: potassium citrate, ferrous sulfate, zinc sulfate, copper sulfate, manganese sulfate, sodium selenate, pyridoxine hydrochloride, riboflavin, thiamine hydrochloride, cyanocobalamin, folic acid, calcium pantothenate, niacinamide, biotin, m-inositol, nucleotide/choline premix, L-carnitine, L-Leucine, and L-tyrosine.

A vitamin C solution (STD2) is prepared by adding ascorbic acid to a water solution with agitation.

All STD1 and STD2 solutions are then added to the refrigerated batch, with agitation. The appropriate amount of ingredient dilution water is then added to the batch to achieve a target total solids level of 29.0-32.0%. The final batch is then subjected to appropriate thermal treatment and filled into a suitable container under an aseptic conditions and processes.

1. A concentrated liquid human milk fortifier comprising from about 5% to about 50% by weight extensively hydrolyzed casein protein, on a dry weight basis, lutein, and a stabilizer system comprising an octenyl succinic anhydride modified corn starch and a low acyl gellan gum.

2. The concentrated liquid human milk fortifier of claim 1, comprising from about 20% to about 40% by weight extensively hydrolyzed casein, on a dry weight basis.

3. The concentrated liquid human milk fortifier of claim 1, wherein the lutein concentration is at least about 50 mcg/liter, based on an as-fed basis.

4. The concentrated liquid human milk fortifier of claim 3, wherein the concentrated human milk fortifier further comprises at least about 30 mg/liter docosahexaenoic acid, based on an as-fed basis, wherein the weight ratio of lutein (mcg) to docosahexaenoic acid (mg) is from about 1:2 to about 10:1.

5. The concentrated liquid human milk fortifier of claim 4, wherein the concentrated human milk fortifier comprises from about 54 to about 360 mg/liter docosahexaenoic acid, based on an as-fed basis, wherein the weight ratio of lutein (mcg) to docosahexaenoic acid (mg) is from about 1:2 to about 10:1.

6. The concentrated liquid human milk fortifier of claim 4, wherein the octenyl succinic anhydride modified corn starch is present in an amount of from about 0.1% to about 3.5% by weight of the concentrated liquid human milk fortifier.

7. (canceled)

8. The concentrated liquid human milk fortifier of claim 4, wherein the low acyl gellan gum is present in an amount of from greater than 125 to about 800 ppm.

9. (canceled)

10. The concentrated liquid human milk fortifier of claim 1, further comprising carbohydrate, fat, vitamins and minerals.

11. The concentrated liquid human milk fortifier of claim 1, wherein the concentrated liquid human milk fortifier is carrageenan-free.

12. The concentrated liquid human milk fortifier of claim 1, wherein the concentrated liquid human milk fortifier comprises from about 170 to about 1360 mcg/liter of lutein.

13. The concentrated liquid human milk fortifier of claim 12, wherein the concentrated liquid human milk fortifier further comprises from about 30 to about 1200 mg/liter of docosahexaenoic acid, wherein the weight ratio of lutein (mcg) to docosahexaenoic acid (mg) is from about 1:2 to about 10:1.

14. The concentrated liquid human milk fortifier of claim 12, wherein the lutein comprises at least about 20% by weight of added lutein.

15. The concentrated liquid human milk fortifier of claim 12, wherein the human milk fortifier comprises a combination of free lutein and zeaxanthin from a single source being a crystalline extract of Tagetes erecta in which the free lutein represents from 85% to 95% by weight of the combination and the free zeaxanthin represents from about 5% to about 15% by weight of the combination.

16. A concentrated liquid human milk fortifier comprising from about 10% to about 50% by weight extensively hydrolyzed casein protein, on a dry weight basis, at least 50 mcg/liter lutein, as fed, and a stabilizer system comprising from about 0.6% to about 2.0% by weight of an octenyl succinic anhydride modified corn starch and from about 125 to about 800 ppm low acyl gellan gum.

17. The concentrated liquid human milk fortifier of claim 16 comprising from about 20% to about 40% by weight extensively hydrolyzed casein protein, on a dry weight basis.

18. The concentrated liquid human milk fortifier of claim 17 comprising from about 0.8% to about 1.5% by weight of an octenyl succinic anhydride modified corn starch.

19. The concentrated liquid human milk fortifier of claim 18 comprising from about 150 to about 400 ppm low acyl gellan gum.

20. The concentrated liquid human milk fortifier of claim 16, wherein the concentrated liquid human milk fortifier comprises from about 50 to about 1150 mcg/liter of lutein, on an as-fed basis.

21. The concentrated liquid human milk fortifier of claim 16, wherein the concentrated liquid human milk fortifier comprises a combination of free lutein and zeaxanthin from a single source being a crystalline extract of Tagetes erecta in which the free lutein represents from 85% to 95% by weight of the combination and the free zeaxanthin represents from about 5% to about 15% by weight of the combination.

22. An aseptically-sterilized concentrated liquid human milk fortifier comprising from about 10% to about 50% by weight extensively hydrolyzed casein protein, on a dry weight basis, at least 170 mcg/liter lutein, and a stabilizer system comprising from about 0.6% to about 2% by weight of an octenyl succinic anhydride modified corn starch and from about 125 to about 800 ppm low acyl gellan gum.

23. The aseptically-sterilized concentrated liquid human milk fortifier of claim 22, wherein the lutein concentration is at least about 170 mcg/liter, or about 0.85 mcg of lutein per a 5 mL unit
